(19) United States
(12) Patent Application Publication
(10) Pub. No.: US 2026/0249500 A1
(43) Pub. Date: Aug. 27, 2026

(54) CUTTING DEVICE FOR CUTTING A STRIP-SHAPED MATERIAL, IN PARTICULAR A TACKY CORD STRIP, AND METHOD FOR SETTING A CUTTING GAP BETWEEN AN UPPER BLADE AND A LOWER BLADE OF A CUTTING DEVICE FOR CUTTING A STRIP-SHAPED MATERIAL, IN PARTICULAR A TACKY CORD STRIP

(71) Applicant: Fischer TireTech Germany GmbH, Burgkunstadt (DE)

(72) Inventor: Frank SCHMIDT, Thurnau (DE)

(21) Appl. No.: 19/536,647

(22) Filed: Feb. 11, 2026

(30) Foreign Application Priority Data
Feb. 25, 2025 (DE) 10 2025 107 143.8

(51) Int. Cl. B26D 5/00; B26B 5/00; B26D 1/08; B26D 7/00; B26D 7/08; B26D 7/26

(52) U.S. Cl. CPC B26D 5/00; B26B 5/003; B26D 1/085; B26D 7/08; B26D 7/26; B26D 2007/005

(57) ABSTRACT

A cutting device for cutting a strip-shaped material, including a beam-shaped lower blade and a beam-shaped upper blade that is moved vertically relative to the positionally fixed lower blade. The lower blade is disposed on a blade carrier that is movable linearly and horizontally on a device frame and is movable by an actuator linearly so that the position of the lower blade relative to the upper blade is variable and a cutting gap between the two blades is adjustable. A further device detects the horizontal movement of the lower blade relative to the upper blade. The device includes a sensor that detects a sensor signal representing a measure of the motion path of the blade carrier effected by way of the actuator and provides it to a processing device which is specified to ascertain path information defining the motion path based on the sensor signal. A display unit displays the path information.

### CROSS-REFERENCE TO RELATED APPLICATIONS

The present application claims priority of DE 10 2025 107 143.8, filed Feb. 25, 2025, the priority of this application is hereby claimed, and this application is incorporated herein by reference.

### BACKGROUND OF THE INVENTION

The invention relates to a cutting device for cutting a strip-shaped material, in particular a tacky cord strip, comprising a beam-shaped lower blade and a beam-shaped upper blade which for cutting is moved vertically in terms of the positionally fixed lower blade, wherein the lower blade is disposed on a blade carrier, which blade carrier is mounted so as to be movable linearly and horizontally on a device frame and is movable by way of actuating means linearly in such a manner that the position of the lower blade relative to the upper blade is variable and a cutting gap provided between the two blades is adjustable, and a device for detecting the horizontal movement of the lower blade relative to the upper blade.

Cutting devices of the type described are used, for example, in the context of tire production. They are used to cut strip-shaped material, in particular a tacky cord strip, either steel cord or textile cord. The term “cutting device” is understood to include different types of machines. The latter are roughly subdivided into scissors and slitters. Used, for example, as scissors are guillotine scissors, thus striking scissors with a beam-shaped and vertically movable upper blade and a beam-shaped and positionally fixed lower blade, as presently considered, circular blade scissors or roller scissors with a rotating and horizontally movable circular blade and a positionally fixed cutter bar, or scissors with a fast-rotating saw blade. These scissors are used to cut individual portions of strips from an endless strip. Different such scissors are described, for example, in DE 20 2013 103 082 U. A slitter is used to longitudinally divide an endless strip in such a way that two or more sub-strips are created. Here, two interacting circular blades that separate the material are used in most instances.

Irrespective of the type of cutting device, the respective blade systems are subjected to a certain degree of wear. Therefore, corresponding maintenance or adjustment work has to be performed, depending on the workload and wear.

Presently, a cutting device in the form of guillotine scissors with a beam-shaped lower blade and a vertically movable beam-shaped upper blade is discussed. During operation, the two blades are subjected to a certain degree of wear. Depending on the workload and wear, the originally set cutting gap between the two blades changes in the process. This cutting gap separates the lower blade from the upper blade which vertically passes by the latter, wherein the strip material which is to be cut is received in the cutting gap during the cutting operation. If, proceeding from an ideal width set in terms of the strip material to be cut, the cutting gap changes in terms of its width, the cutting quality is compromised which may even result in scrap material being produced.

Consequently, the cutting gap has to be set again when the width of the cutting gap has changed due to wear. In known cutting devices, this is performed manually after a prior visual check of the width of the cutting gap by the maintenance personnel. For this check, the operator checks and measures the cutting gap by means of an optical measuring apparatus, also referred to as a spy, and can thus determine the specific gap width. In order to enable the setting of the gap, the lower blade is disposed so as to be horizontally movable, thus can be adjusted horizontally in terms of the upper blade which is positionally fixed in the horizontal direction. As is described in DE 20 2013 103 082 U1, for example, the lower blade is typically fixedly disposed on a side of a worktop that is used as a support for the strip material, wherein the worktop and, conjointly with the latter, the lower blade are adjustable. For this purpose, the worktop is mounted so as to float horizontally in the device frame and can accordingly be locked, for example clamped, in the respective axial position assumed in or counter to the conveying direction of the strip. Disposed on the side of the worktop lying opposite the lower blade, in each case on the left and the right, are in most instances two actuation devices comprising actuation nuts which are to be rotated and by way of which a fine adjustment of the axial movement is possible. By way of such an actuation device on the respective side, the position of the worktop can be set and corrected in the longitudinal direction, thus setting the cutting gap and the profile of the lower blade relative to the upper blade. The actuation nuts are preloaded by way of spring elements or spring assemblies that apply a defined counterforce between the worktop and the device frame. Depending on the rotating direction of the actuation screws, the lower blade can thus be finely adjusted by adjusting the worktop, and the cutting or chopping gap can be increased or decreased. The variation of the width of the cutting gap in the context of this setting or adjustment is typically very minor, the adjustment in most instances taking place in the range of approx. 0.002-0.2 mm.

A suitable mechanical measuring apparatus in the form of a dial indicator is used in order to be able to detect this minor motion path, which dial indicator has as probe and a mechanical display, wherein the measuring apparatus is disposed so as to be positionally fixed on the device frame, the probe bearing on the worktop. A corresponding worktop movement is detected by way of the probe and displayed at the mechanical, thus analog, display of the dial indicator, where it is read by the maintenance personnel. This type of detection and continual checking of the actuating movement by way of the measuring apparatus is time-consuming and to some extent difficult because there is often no easy access to the measuring apparatus for reading the indicated values, due to the compact design of the cutting device in this region and due to the width of the cutting device. Therefore, this maintenance is associated with great complexity and requires careful planning.

### SUMMARY OF THE INVENTION

The invention is thus based on the object of specifying a cutting device that is improved in comparison to the above.

In order to achieve the object it is provided according to the invention in a cutting device of the type mentioned at the outset that the device comprises at least one sensor by way of which a sensor signal representing a measure of the motion path of the blade carrier effected by way of the actuating means is able to be detected and provided to a processing device which is specified to ascertain a path information defining the motion path based on the measured value, wherein the path information is able to be displayed at a display unit.

The invention provides the disposal of a sensor delivering a measured value in the form of an electrical sensor signal, which sensor signal is a measure of the motion path of the lower blade in the horizontal direction relative to the upper blade. The sensor signal is provided to a processing device which is connected to the sensor and processes the sensor signal using a suitable processing algorithm and based on the latter ascertains a path information representing the actual length of movement by way of which the lower blade has been displaced by the actuating means. This path information thus describes the actual adjustment path of the lower blade by way of the actuating means. This value is then displayed at a display unit that communicates with the processing device. Since this display unit can be disposed at any arbitrary position where it is visible to the maintenance personnel performing the blade adjustment by way of the actuating means, the adjustment can consequently take place in a simple manner.

Usually, the cutting gap is set to an ideal initial value ex works, i.e. the lower blade is moved to a defined initial position at the factory, this being performed by a corresponding setting of the position of the worktop by way of the actuating means. The worktop is then fixed in this initial position. If a visual check by way of the optical measuring means, such as the spy already described, by way of which the region of the cutting gap can be observed and a measurement of the gap is possible, has the result that the cutting gap no longer has the defined initial width, the two blades thus no longer being in the initial position, the maintenance personnel will perform the adjustment. The sensor, which then provides the corresponding information for the actuating movement, proceeding from the given initial position of the lower blade, or of the worktop, which from the point of view of the sensor is a zero position, detects the corresponding motion path, which for decreasing the cutting gap runs in the direction of the upper blade and for increasing the cutting gap runs in the opposite direction. Thus, not the actual gap width is detected and displayed, but only the actual motion path of the lower blade, or of the worktop, respectively, proceeding from the position at the beginning of the setting procedure, the latter position being a zero position for the sensor. Due to the adjustment being substantially easier to check, this adjustment procedure is significantly simpler for the maintenance personnel, just as the detection of the path is also significantly more accurate due to the electronic or digital detection of the motion path by way of the sensor, so that even adjustments in the micrometer range can be detected and performed with high precision.

It is conceivable here that the sensor signal is automatically detectable at the beginning of an actuating movement effected by the actuating means. Thus, when an adjustment is performed, the recording of a signal and thus the detection of the path are initiated immediately as said adjustment begins, and the corresponding sensor signals detected continuously in real time are detected and the path information is ascertained and displayed by the processing device in real time. Alternatively, it is conceivable that the sensor signal is detectable when a detection command is entered by a user by way of the processing device. Thus, the user enters a corresponding command to the effect that he/she wants to perform an adjustment procedure at the processing device, or a corresponding input means, for example also the display unit if the latter is embodied as a touchscreen, this resulting in the sensor being actuated and delivering corresponding sensor signals and the path measurement being performed.

It is conceivable that an adjustment is only possible over a limited, previously defined, actuation path in one adjustment procedure. This serves to prevent an excessive actuation path being unintentionally set, and damage to the blade system arising when operation resumes. For example, the maximum adjustment path within one adjustment procedure can be limited to at most 0.06 mm. In order to avoid that this maximum actuation path is exceeded, it can be provided in a refinement of the invention that the processing device is specified to compare the sensor signal or the ascertained path information with a reference signal or a reference information and to display the comparison result at the display unit. This maximum permissible actuation path can thus be used as a reference in terms of which a continuous comparison of the actual actuation path is performed. For example, if the actual actuation path is identical to the reference, a corresponding alarm signal can be displayed that indicates that further adjustment should not take place. In the process, the processing device can either compare the sensor signal directly with a reference signal, or compare the ascertained path information with a reference information, thus the specific maximum value of the permissible actuation path.

The ascertained path information is then displayed as a numerical value at the display unit. Because the sensor continuously detects the actuating movement, the displayed value is thus continually updated, i.e. the actual actuation path being displayed to the maintenance personnel in real time, so that it can be identified with high accuracy to what extent the adjustment has been performed and whether the actuation target has been achieved. As described, the actuation path is typically very small, often being in the micrometer range. An information in the form of color may also be associated with the display of the numerical value. For example, if an upper limit of 0.06 mm is set for the maximum adjustment, which must not be exceeded, the display can be against a green background as long as the actual actuation path is less than 0.06 mm, for example, and the display can switch to a red background once the actuation limit of 0.06 mm has been reached. It is also conceivable to switch the display to yellow when approaching the actuation limit, for example when reaching an actuation path of 0.05 mm, so that the personnel is warned just before reaching the adjustment limit. Thus, a type of traffic light system can be provided in terms of the additional information in the form of color.

As an alternative to displaying a specific numerical value it is also conceivable to present the path information in the form of a graphical representation, e.g. as a bar chart which has a path graduation of e.g. 0.0 mm-0.06 mm and which is assigned a marker in the form of a pointer which points to the set graduation value. Other graphical representations that present the variable path information are of course also conceivable.

It is also conceivable that the processing device for varying the cutting gap is specified to ascertain a length of movement for adjusting the lower blade to be effected by means of the actuating means, said length of movement being able to be displayed at the display unit. By means of a suitable processing algorithm it can also be additionally ascertained by the processing device which specific actuation path is to be actuated in the impending adjustment procedure in order to adjust the cutting gap back to a dimension that is ideal or preferable for cutting the strip material. For this purpose, the value of the actual width of the cutting gap, ascertained by the personnel prior to the beginning of the actuation procedure by a visual check and by measurement, can, for example, be entered at an input device, whereupon the processing device, expediently while taking into account material parameters of the strip material to be cut, such as the type of strip (textile cord or steel cord), the strip thickness, the strip properties and similar, ascertains an ideal width dimension for the cutting gap and, proceeding from the entered actual width value and the target width value, determines and displays the actuation path to be implemented. The maintenance personnel can thereupon perform the adjustment exactly under continuous sensor monitoring, so that the desired target value is achieved.

In a refinement of the invention, the actuating means can comprise two separate actuation devices which by way of the blade carrier are coupled in the region of the lateral ends of the latter and which are separately activatable. As described, lateral actuation devices, which when manually activated comprise two actuation nuts, are typically used, by way of which the blade carrier and thus the lower blade are linearly displaced. In this context it is expedient to quasi assign a separate sensor to each one of the mechanical actuation devices, thus to the respective actuation mechanism, which is activated by way of an actuation nut, so that the actuation path is ascertained with high accuracy at both actuation positions. On the one hand, this permits a highly accurate separate adjustment at the two end regions, as well as setting defined tilting about a vertical axis, or resolving arising tilting by way of marginally different actuating movements across the two separate actuation devices.

The actuation devices per se can be spindles with actuation nuts that are to be manually activated, or spindle drives which are activatable by way of a respective servomotor. In the case of manual activation, the corresponding actuation nuts are provided, which can be manually activated using a suitable tool and are connected to the spindle by way of fine pitch thread, such that highly accurate and precise actuation is possible. Alternatively, it is also conceivable that spindle drives are used, which have a spindle and a spindle nut driven by way of a servomotor, wherein fine pitch threads are also provided here. Thus, different embodiments of suitable actuation devices are conceivable, which always have to be conceived in such a way that highly precise actuation paths in the micrometer range are possible.

As has already been explained, to sensors which are horizontally spaced apart from one another are advantageously provided. They are thus spaced apart from one another along the blade carrier, when viewed horizontally, and are positioned laterally, or at lateral ends of the blade carrier. They each deliver separate sensor signals and are separately evaluated so that it is possible to accurately ascertain the actuation path at two positions and in terms of each actuation device when two separate actuation devices are used. This also allows highly precise and different actuation paths to be implemented on both sides, for example a motion path of 0.02 mm by way of the one actuation device, and the motion path of 0.03 mm or similar by way of the other actuation devices, such that the lower blade can ultimately be set either only horizontally in a synchronous manner on both sides, or else so as to be tilted to a minor extent about a vertical axis if required.

The, or each, sensor is preferably embodied as a probe, comprising a housing and a pin movable relative to the housing. Thus, the pin can be moved in and out of the housing, depending on the respective displacement direction. Each ever-so-marginal relative movement of the pin in relation to the housing generates a position-specific sensor signal, i.e. corresponding measurement or position transducers are provided in the housing which detect the actual position of the probe relative to the housing with high precision, wherein the sensor signal is then provided to the processing device for further processing.

As an alternative to using such a probe, it is also conceivable that the, or each, sensor is a photo-optical sensor comprising a housing with a device emitting a scanning light beam and detecting reflected. While the probe performs a quasi-mechanical scan, contactless scanning and thus ascertaining of the path takes place by way of a photo-optical sensor. This sensor has transmitting and receiving means which are received in a housing and by way of which a scanning light beam directed onto the component to be moved is emitted and a beam reflected by the component is detected, whereupon the actual sensor signal is then generated based thereon and provided to the processing device.

The housing here can be connected to the blade carrier, and the pin can bear on the device frame, or the scanning light beam can be directed onto the device frame, respectively. This means that the housing is moved in this case, while the pin bears so as to be positionally fixed on the device frame, or the scanning light beam is directed onto the positionally fixed device frame, respectively. Of course, the arrangement may also be reversed.

Once adjusting has been performed, the blade carrier, thus the worktop, is to be anchored in the assumed terminal position again, and the assumed position of the lower blade is consequently to be fixed. For this purpose, suitable, mechanically or hydraulically activatable clamping means are provided, which are easy to release for an adjustment procedure, on the one hand, but are also easy to clamp again, on the other hand, at the same time permitting a sufficiently firm locking mechanism.

Apart from the cutting device per se, the invention furthermore relates to a method for setting a cutting gap between an upper blade and a lower blade of a cutting device for cutting a strip-shaped material, in particular tacky cord strip, wherein the cutting device comprises a beam-shaped lower blade and a beam-shaped upper blade which for cutting is moved vertically in terms of the positionally fixed lower blade, wherein the lower blade is disposed on a blade carrier, which blade carrier is mounted so as to be movable linearly and horizontally on a device frame and is movable by way of actuating means linearly in such a manner that the position of the lower blade relative to the upper blade is variable and a cutting gap provided between the two blades is adjustable, and a device for detecting the horizontal movement of the lower blade relative to the upper blade. This method is characterized in that, by means of at least one sensor of the device, a sensor signal representing a measure of the motion path of the blade carrier effected by way of the actuating means is detected and provided to a processing device which ascertains a path information defining the motion path based on the measured value, wherein the path information is displayed at a display unit.

It can be provided here that the sensor signal is detected automatically by way of actuating means at the beginning of an actuating movement, the detection operation thus beginning automatically and immediately as the adjustment is initiated. Alternatively, it can be provided that the sensor signal is detected when a detection command is entered by a user by way of the processing device. Here, the beginning of signal detection is thus triggered by the input of the command.

Furthermore, the sensor signal or the ascertained path information can be compared with the reference signal or reference information by the processing device, and the comparison result can be displayed at the display unit.

The path information displayed to the maintenance personnel can preferably be displayed as a numerical value at the displayed unit, wherein this value can additionally be assigned a colored information which indicates whether the already effected actuating path lies within defined permissible actuating limits. Alternatively, it is also conceivable that the path information is displayed in the form of a graphical representation.

It can furthermore be provided that the length of movement for adjusting the lower blade to be effected by means of actuating means for varying the cutting gap is ascertained by the processing device, said length of movement being displayed at the display unit.

A probe comprising a housing and a pin which is movable relative to the housing, or a photo-optical sensor comprising a housing with a device emitting a scanning light beam and detecting reflected light, can be used as a sensor.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a schematic illustration of a cutting device according to the invention in a lateral view,

FIG. 2 shows a plan view of a cutting device according to the invention as a partial view while illustrating the blade carrier of the lower blade with actuating means in a first embodiment,

FIG. 3 shows a plan view of a cutting device according to the invention as a partial view while illustrating the blade carrier of the lower blade with actuating means in a second embodiment,

FIG. 4 shows an enlarged partial view of a cutting device according to the invention while schematically illustrating the arrangement of a sensor in the form of a probe,

FIGS. 5-7 show schematic illustrations of partial views of a cutting device according to the invention for illustrating the adjustment procedure and an assigned display unit,

FIG. 8 shows a partial view of a cutting device with a blade carrier, of fixing means assigned to the latter, and of actuating means of a first embodiment, and

FIG. 9 shows a partial view of a cutting device with a blade carrier, of fixing means assigned to the latter, and of actuating means of a second embodiment.

### DETAILED DESCRIPTION OF THE INVENTION

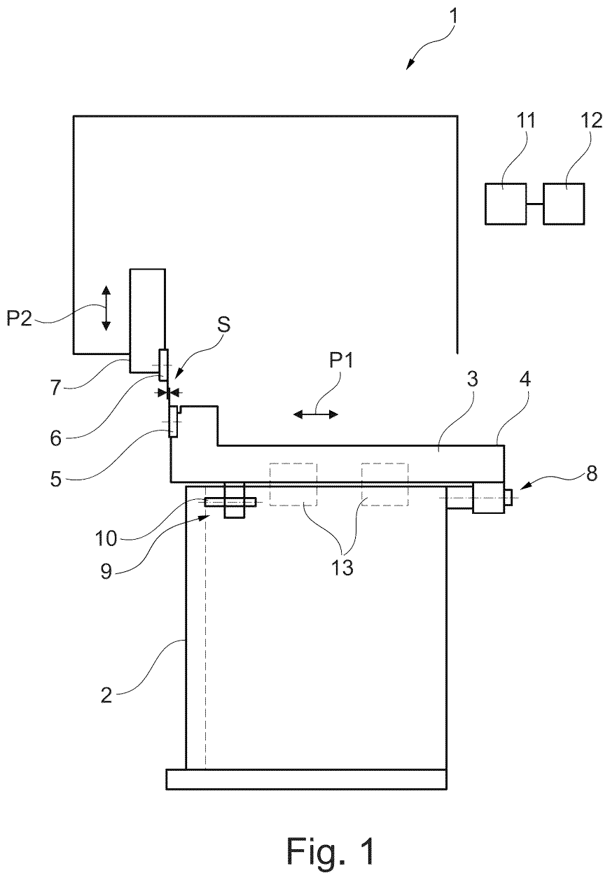

FIG. 1 shows a cutting device 1 according to the invention in the form of guillotine scissors. The cutting device 3 is used for cutting pieces of strips from a strip-shaped endless material, such as a textile cord strip or a steel cord strip, fed to said cutting device 3. The cutting device 1 comprises a device frame 2, which may also be referred to as a machine frame, on which is disposed a blade carrier 3 in the form of a worktop 4 which is movable in a floating manner, or horizontally, as is illustrated by the double arrow P1. A beam-shaped lower blade 5 is disposed on the blade carrier 3. Furthermore provided is an upper blade 6 which is disposed on a further blade carrier 7, the latter being guided by way of guide devices not shown in more detail so as to be vertically movable on the device frame 2, as is illustrated by the double arrow P2. Provided between the lower blade 5 of the upper blade 6 is a cutting gap S which can be set by adjusting the position of the lower blade 5 by horizontally displacing the blade carrier 3, thus the worktop 4. Provided for this purpose are corresponding actuating means 8 which will be described in yet more detail hereunder and are either to be manually activated by screwing corresponding actuating nuts that run on fine pitch thread spindles, or by activating a threaded spindle drive, likewise having a fine pitch thread, by way of servomotors.

In order to detect such an actuating movement with high precision, at least one sensor 9 is provided, the latter preferably being a probe 10. Detected by way of this sensor is an electrical sensor signal representing a measure of the motion path of the blade carrier 3 effected by way of the actuating means 8, and thus of the lower blade 5, which is provided to a processing device 11 which is connected to the sensor 9, or to the probe 10, respectively, said processing device 11, based on the sensor signal, by means of a suitable evaluation algorithm ascertaining a path information that specifies the motion path, wherein the path information is displayed at a display unit 12, for example a monitor. A person performing the adjustment can comfortably see the display unit to the best possible extent while performing the adjustment by way of actuating means 8, so that, apart from detecting the motion path in an electronic or digital form with high precision, comfortable activating and path monitoring is possible.

In order to ascertain whether an adjustment of the lower blade 5, and thus a setting of the width of the cutting gap S, is necessary, a visual check of the cutting gap S, thus optical measuring, is usually performed by the personnel, to which purpose the cutting gap S is visually observed and measured by the person using a suitable optical measuring instrument, also referred to as a spy. It can thus be ascertained whether and, if so, to what extent the cutting gap S has to be corrected, and resulting therefrom by which motion path the lower blade 5 is to be adjusted, wherein this movement in the event of an excessively large cutting gap S takes place toward the upper blade 6, or in the event of an excessively small cutting gap S, which may include a marginal overlap between the upper blade 6 and the lower blade 5, takes place away from the upper blade 6. Once a required adjustment has been established, fixing means 13 by way of which the blade carrier 3 is locked so as to be positionally fixed on the device frame 2 are released. These fixing means are preferably mechanically or hydraulically activatable clamping means. Once released, the adjustment of the lower blade 5 is performed by way of the actuating means 8, wherein due to the continuous detection of the motion path of the blade carrier 3 by way of the sensor 9, and due to the continuous display of the actually performed motion path or actuating procedure at the display unit 12, the person can check the progress of the adjustment procedure with high accuracy, and when the desired target adjustment and thus the desired target position of the lower blade 5 has been reached. The adjustment procedure then terminates, and the blade carrier 3 is again locked by way of the fixing means 13 in such a way that the relative position of the lower blade 5 in relation to the upper blade 6 is fixed again.

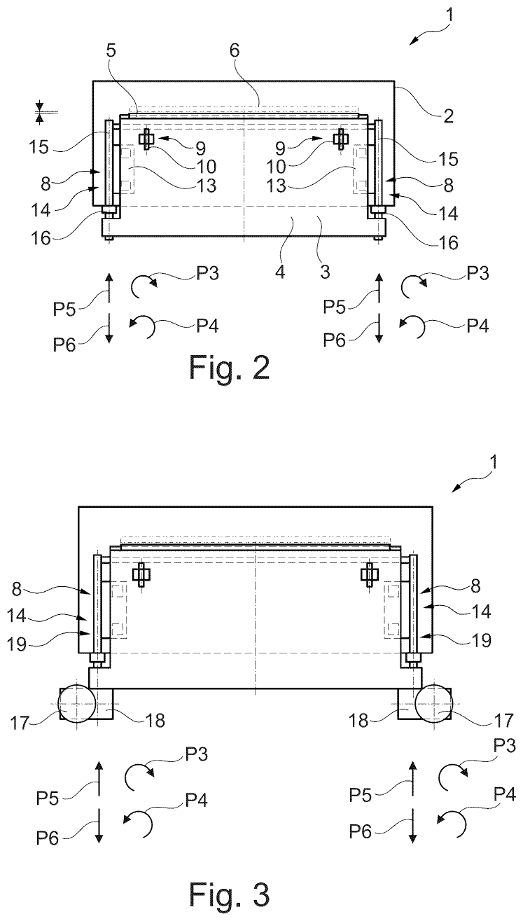

FIG. 2 shows a plan view of a cutting device 1, wherein the device frame 2 and the blade carrier 3 in the form of the worktop 4 and the lower blade 5 are illustrated here, the upper blade 6 being indicated. Likewise indicated are fixing means 13 which are provided on both sides.

Furthermore shown are the actuating means 8 which are implemented in the form of two separate actuation devices 14. The actuation devices 14 are disposed on both sides of the blade carrier 3 and are to be manually operated in the initial example shown. Provided in each case is a fine pitch thread spindle 15, an actuating nut 16 which is to be manually activated in order to displace the blade carrier 3 linearly and horizontally running on each of the fine pitch thread spindles 15. Depending on the direction of rotation, which may be in a clockwise manner or a counterclockwise manner, as is shown by the arrows P3 and P4, the corresponding direction of movement changes, the latter being illustrated by the arrows P5 and P6.

Since each actuation device 14 can be individually activated, a separate adjustment can consequently be performed on both sides, this permitting that the blade carrier 3 can also be tilted marginally about a vertical axis in such a way that an angle between the two cutting edges of the lower blade 5 and of the upper blade 6, which is in the range of a few angular seconds or angular minutes, can be set or compensated for in a precise manner, thus the cutting edges can be set parallel again.

Each actuation device 14 is assigned a sensor 9, again in the form of a probe 10, such that the motion path can ultimately be detected or a corresponding sensor signal be recorded, at both actuation positions. Both sensor signals are provided to the common processing device 11 for ascertaining the path information, wherein the processing device 11 in this case preferably ascertains and displays two separate items of path information that are assigned to the individual actuation devices 14.

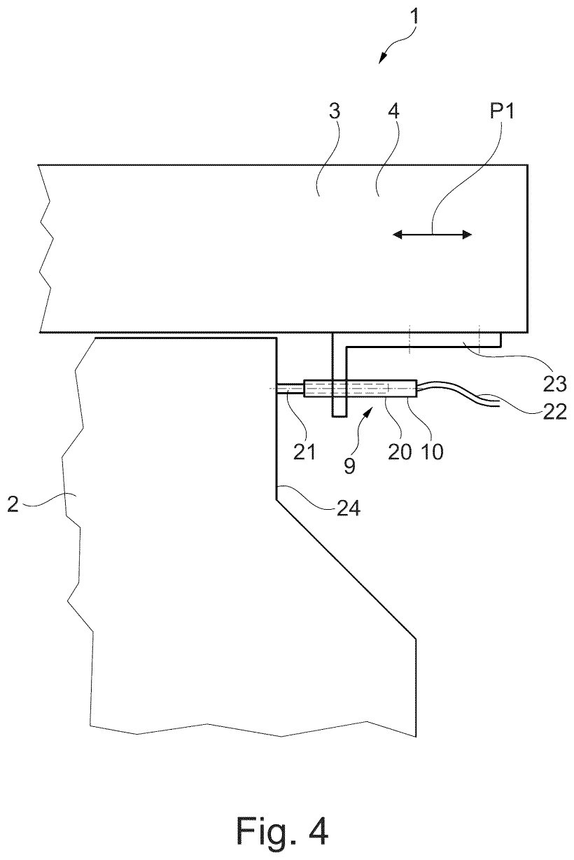

FIG. 3 shows a comparable cutting device 1 as has already been illustrated and explained in FIG. 2. Reference is made to the explanations pertaining to the latter. In this case, the only point of differentiation is that the actuating means 8, or the two actuation devices 14, here are activated in a motorized, thus automatic, manner, for which purpose each actuation device 14 has a separately activatable servomotor 17 with an assigned gearbox 18. The actuation devices 14 furthermore comprise separate threaded spindle drives 19, wherein either the spindle nut or the spindle per se is activated by way of the servomotor 17 and the gearbox 18. Depending on the direction of rotation of the respective servomotor 17, which here too can take place in a clockwise manner and in a counterclockwise manner, as indicated by the arrows P3 and P4, this here too results in a movement in the strip conveying direction, see arrows P5, or counter to the strip conveying direction, see arrows P6.

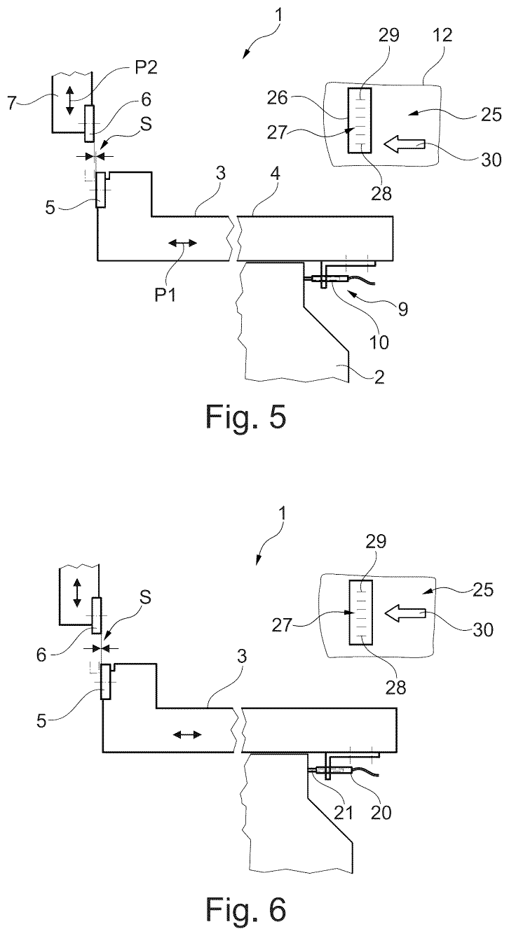

FIG. 4 shows a partial view of the cutting device 1, wherein a blade carrier 3 in the form of the worktop 4 and the device frame 2 are shown in fragments. As indicated by the double arrow P1, the blade carrier 3 is movable horizontally relative to the positionally fixed device frame 2, the blade carrier 3 or the worktop 4 being guided on the latter by way of suitable guides. Furthermore shown is the sensor 9 in the form of the probe 10, comprising a housing 20 and a pin 21 which is movable in and out of the housing 20, whereby two such sensors 9 as already described above can of course also be provided. Integrated in the housing 20 is a suitable detection means for detecting the position of the pin 21, or of the movement of the latter, which detection means delivers the actual sensor signal describing the motion path that is provided to the processing device 11 by way of a communications line 22. The housing 20 is connected to the blade carrier 3, presently the worktop 4, by way of a fastening angle 23, while the pin 21 by way of its tip is supported on a bearing face 24 of the device frame 2. In the event of the displacement of the worktop 4 relative to the positionally fixed device frame, depending on the direction of movement the pin 21 is pushed into the housing 20, or is pushed out of the latter because it is spring-loaded, for example, by way of a spring provided in the housing. Any ever-so-marginal pin movement is detected by way of the detection means and communicated to the processing device 11 by way of corresponding sensor signals, the processing device 11 based thereon ascertaining a corresponding path information which is displayed at the display unit 12.

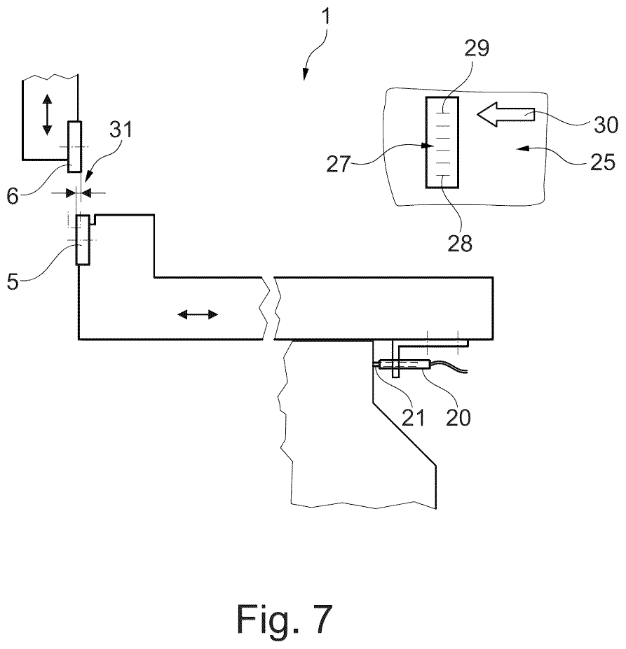

FIGS. 5 to 7 show by way of example and in fragments a cutting device 1 of which are shown the blade carrier 3, or the worktop 4, including the lower blade 5, the device frame 2, the further blade carrier 7 and the upper blade 6 and the cutting gap S. Likewise shown is the display unit 12 at which a corresponding path information 25 ascertained by the processing device 11 is represented, presently in the form of a graphical representation.

In the positioning situation shown in FIG. 5, a cutting gap S is provided, meaning that the upper blade 6 when lowered is displaced laterally next to the lower blade 5 so as to be separated therefrom by the cutting gap S. A sensor 9 is again shown in the form of a probe 10. Purely for explanatory purposes, FIGS. 5 to 7 show an adjustment in which, proceeding from a cutting gap shown in FIG. 5, the lower blade 5 is displaced so far that an overlap with the upper blade 5 would arise, this of course not being the case during operation. This is only to explain the adjustment procedure per se and the change in the position-dependent path information shown in the form of the graphical representation 25.

As described, FIG. 5 shows the initial situation with a provided cutting gap S. If the adjustment starts now, the sensor 9 is immediately switched on either automatically as the first infinitesimal movement starts, said sensor 9 supplying immediately and continuously corresponding sensor signals which lead to the items of path information being ascertained, the latter being represented as a graphical representation 25. Alternatively of course, the measuring operation can also be started by entering a corresponding command which the user can provide also by way of the display unit 12, which is embodied as a touchscreen, for example.

Shown by way of example is a bar chart 26 on which the set actual motion path is continually displayed. The bar chart 26 has a graduation 27, wherein the lowermost graduation value 28 is the zero point, while the upper graduation value 29 is the maximum value of the motion path. Assuming that the maximum motion path is 0.06 mm, the lowermost graduation value 28 would be 0.0 mm and the uppermost graduation value 29 would be 0.06 mm. The graduation can be in steps of 0.01 mm, for example. Furthermore shown is a marking 30 indicating the actual motion path. This marking 30 here is shown as an arrow, the latter ultimately pointing toward the zero point, thus the lowermost graduation value 28, because the adjustment procedure has just started.

Assuming that the blade carrier 3 is moved to the left, meaning that the lower blade 5 is moved toward the upper blade 6. This has the effect that the cutting gap S decreases, ultimately being set to 0, see FIG. 6, meaning there is no longer a gap so to speak, when the upper blade 6 moves past the lower blade 5. This actuating movement is illustrated within the graphical representation 25, the marking 30 has moved up and now ultimately points toward the center of the graduation 27, because an adjustment by 0.03 mm is assumed to have taken place. The pin 21 has been pushed slightly into the housing 20, as can be seen.

If the further adjustment is performed in this direction of movement, the lower blade 5 is pushed so as to overlap with the upper blade 6, meaning that both blades overlap one another, as is indicated by the illustrated overlap 31. The pin 21 has been pushed even further into the housing 20. This position is of course also detected with high precision and is reflected in the representation 25. As can be seen, the further marking 30 has moved even further upward, now pointing toward the uppermost graduation value 29, the latter indicating the maximum permissible actuation path of 0.06 mm. It is thus unequivocally and immediately identifiably shown to the person performing the adjustment that the maximum adjustment has been performed, and the adjustment procedure has to be terminated. Reaching the maximum adjustment path can also be associated with a corresponding colored symbol, meaning that the display unit 12 lights up or flashes in the red, for example, or the marking 30 lights up or flashes in red, such that a quasi warning signal is provided, which indicates that the maximum adjustment has been reached. It would also be conceivable, for example, to provide a type of traffic light system in terms of representing the colored information. In the event of an adjustment of 0.0 mm-0.05 mm, for example, the display unit would have a green background, or the marking 30 would be illustrated in green; in the event of a larger motion path of more than 0.5 mm the color would change to yellow, while the color would change to red when reaching the maximum adjustment of 0.06 mm. In this way, an additional colored signal is provided to the person.

While a graphical representation 25 for indicating the path information is shown in the example described, it is of course also conceivable that specific numerical values that indicate the actual motion path are ascertained and represented as path information. Thus, instead of the bar chart 26, a corresponding, continuously changing numerical value would be illustrated, the latter ultimately running from 0.0 mm to 0.06 mm, if the latter is the maximum upper path limit. Here too, a corresponding colored information as described above can of course be additionally provided.

It is conceivable that the processing device 11 is also specified for ascertaining a motion path to be set, the latter having to be set for reaching an ideal width of the cutting gap S, said motion path also being able to be additionally displayed as a numerical value at the display unit 12. As described, the person prior thereto ascertains the provided actual width of the cutting gap S using an optical measuring apparatus. This numerical value can be entered by the user of the processing device 11, for example by way of the display unit 12, said processing device 11 thereafter ascertaining the ideal gap width, for example also while taking into account specific material parameters of the strip material to be cut, and ascertaining the required motion path for reaching this ideal gap width proceeding from the actual gap width using a suitable algorithm, and then displaying this value. In this way, the person skilled in the art, in addition to having potentially ascertained the required motion path himself/herself, also obtains respective information from the system. Due to the continuous detection of the actual motion path, the person can now see precisely when the adjustment by the required distance has been performed.

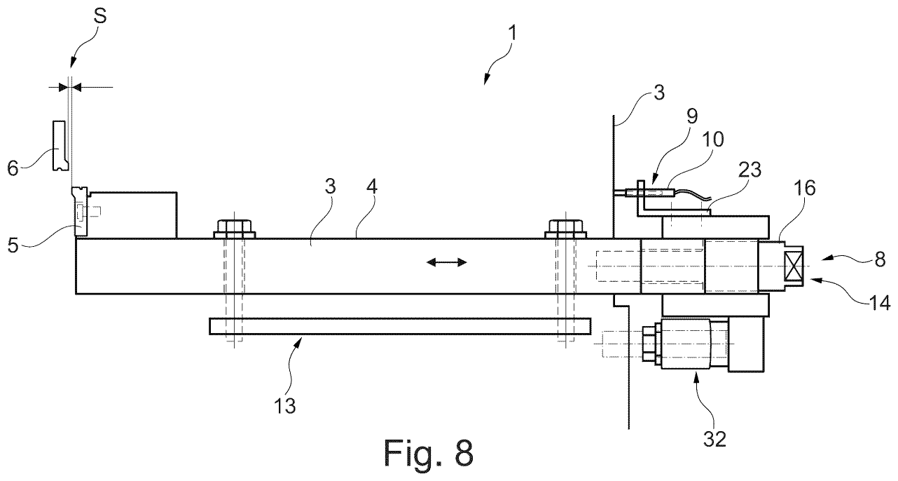

FIG. 8 shows a partial view of a cutting device 1 in a lateral view, in which a first design embodiment is schematically shown. Illustrated again is the blade holder 3 in the form of the worktop 4 which is mounted so as to be movable or floating, as described, and can be fixed or clamped in position by way of corresponding fixing means 13. Also shown are the lower blade 5 and the upper blade 6 and the provided cutting gap S.

Likewise schematically shown is the device frame 3 and a sensor 9, the latter again in the form of a probe 10 which is connected to the blade carrier 3, or to the worktop 4, by way of the fastening angle 23. Furthermore shown is the actuating means 8, or one of the two actuation devices 14, the latter here being illustrated as manual actuating means 8 with a corresponding actuating nut 16. The actuation devices 14 comprise in each case a schematically shown spring assembly 32 which is supported on the device frame 3 and against which the worktop 4 is movable. A preload acting counter to the movement of lower blade 5 in the direction of the upper blade 6 is built up by this spring assembly 32, so that the system is preloaded in such a way that operation by way of the actuating nut 16 takes place counter to the spring assembly 32 when the lower blade 5 is to be moved closer to the upper blade 6.

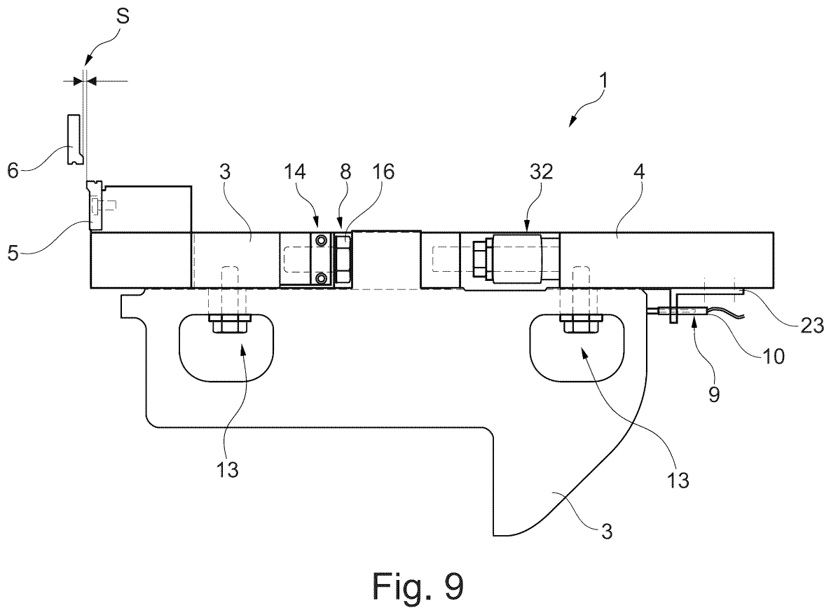

FIG. 9 shows a cutting device 1 in an individual partial view, wherein shown again here is the blade carrier 3 in the form of the worktop 4 as well as the corresponding fixing means 13 by way of which the worktop 4 is fixed on the device frame 3. Likewise shown are the lower blade 5 and the upper blade 6 and the cutting gap S. In this design embodiment, the sensor 9, again in the form of a probe, is disposed below the worktop 4 by way of the fastening angle 23, whereby it is to be noted at this point that fastening elements other than such a screw-fitted fastening means 23 can of course in principle also be used in all design embodiments for positioning and fastening the respective transmitter 9.

Here too, an actuating means 8 is provided, of which again only an actuation device 14 is shown, the latter again having to be manually activated and having a corresponding actuating nut 16. The spring assembly 32, which is also provided here, is disposed quasi in series with the respective actuation device 14. However, the fundamental function is the same as has been described above in the context of the design embodiment according to FIG. 8.

While specific embodiments of the invention have been shown and described in detail to illustrate the inventive principles, it will be understood that the invention may be embodied otherwise without departing from such principles.

We claim:

1. A cutting device for cutting a strip-shaped material, in particular a tacky cord strip, comprising a beam-shaped lower blade and a beam-shaped upper blade which for cutting is moved vertically in terms of the positionally fixed lower blade, wherein the lower blade is disposed on a blade carrier, which blade carrier is mounted so as to be movable linearly and horizontally on a device frame and is movable by way of actuating means linearly in such a manner that the position of the lower blade relative to the upper blade is variable and a cutting gap provided between the two blades is adjustable, and a device for detecting the horizontal movement of the lower blade relative to the upper blade, wherein the device comprises at least one sensor by way of which a sensor signal representing a measure of the motion path of the blade carrier effected by way of the actuating means is able to be detected and provided to a processing device which is specified to ascertain a path information defining the motion path based on the sensor signal, wherein the path information is able to be displayed at a display unit.

2. A cutting device according to claim 1, wherein the sensor signal is automatically detectable at the beginning of an actuating movement effected by way of the actuating means, or in that the sensor signal is detectable when a detection command is entered by a user by way of the processing device.

3. A cutting device according to claim 1, wherein the processing device is specified to compare the sensor signal or the ascertained path information with a reference signal or a reference information, and to display the comparison result at the display unit.

4. A cutting device according to claim 1, wherein the path information is able to be displayed as a numerical value or as a graphical representation at the display unit.

5. A cutting device according to claim 1, wherein the processing device for varying the cutting gap is specified to ascertain a length of movement for adjusting the lower blade to be effected by means of the actuating means, said length of movement being able to be displayed at the display unit.

6. A cutting device according to claim 1, wherein the actuating means comprise two separate actuation devices which by way of the blade carrier are coupled in the region of the lateral ends of the latter and which are separately activatable.

7. A cutting device according to claim 6, wherein the actuation devices are spindles with actuation nuts to be manually activated, or are spindle drives which are activatable by way of a respective servomotor.

8. A cutting device according to claim 1, wherein provided are two sensors which are horizontally spaced apart from one another.

9. A cutting device according to claim 1, wherein the, or each, sensor is a probe comprising a housing and a pin movable relative to the housing, or in that the, or each, sensor is a photo-optical sensor comprising a housing with a device emitting a scanning light beam and detecting reflected light.

10. A cutting device according to claim 9, wherein the housing is connected to the blade carrier and the pin bears on the device frame or the scanning light beam hits the device frame or vice-versa.

11. A cutting device according to claim 1, wherein provided are fixing means by way of which the linearly movable blade carrier is able to be fixed in its position relative to the device frame.

12. A cutting device according to claim 11, wherein the fixing means are mechanically or hydraulically activatable clamping means.

13. A method for setting a cutting gap between an upper blade and a lower blade of a cutting device for cutting a strip-shaped material, in particular a tacky cord strip, wherein the cutting device comprises a beam-shaped lower blade and a beam-shaped upper blade which for cutting is moved vertically in terms of the positionally fixed lower blade, wherein the lower blade is disposed on a blade carrier, which blade carrier is mounted so as to be movable linearly and horizontally on a device frame and is movable by way of actuating means linearly in such a manner that the position of the lower blade relative to the upper blade is variable and a cutting gap provided between the two blades is adjustable, and a device for detecting the horizontal movement of the lower blade relative to the upper blade for adjusting the width of the cutting gap, wherein, by means of at least one sensor of the device, a sensor signal representing a measure of the motion path of the blade carrier effected by way of the actuating means is detected and provided to a processing device which ascertains a path information defining the motion path based on the sensor signal, wherein the path information is displayed at a display unit.

14. The method according to claim 13, wherein the sensor signal is automatically detected at the beginning of an actuating movement, or in that the sensor signal is detected when a detection command is entered by a user by way of the processing device.

15. The method according to claim 13, wherein at the processing device the sensor signal or the ascertained path information is compared with a reference signal or a reference information, and the comparison result is displayed at the display unit.

16. The method according to claim 13, wherein the path information is displayed as a numerical value or as a graphical representation at the display unit.

17. The method according to claim 13, wherein for varying the cutting gap, the length of movement to be effected for adjusting the lower blade to be effected by means of the actuating means is ascertained at the processing device, said length of movement being displayed at the display unit.

18. The method according to claim 13, wherein a probe comprising a housing and a pin movable relative to the housing is used as a sensor, or in that a photo-optical sensor comprising a housing with device emitting a scanning light beam and detecting reflected light is used as a sensor.
